(19) United States
(12) Patent Application Publication
(10) Pub. No.: US 2011/0089244 A1
(43) Pub. Date: Apr. 21, 2011

(54) ELECTRO-OPTICAL READER WITH VISIBLE INDICATION OF SUCCESSFUL DECODE IN LINE OF SIGHT OF OPERATOR

(75) Inventors: Edward BARKAN, Miller Place, NY (US); Christopher Warren BROCK, Manorville, NY (US)

(73) Assignee: SYMBOL TECHNOLOGIES, INC., Holtsville, NY (US)

(21) Appl. No.: 12/582,165

(22) Filed: Oct. 20, 2009

(51) Int. Cl. G06K 7/10

(52) U.S. Cl. 235/472.01

(57) ABSTRACT

A coded symbol is electro-optically read by a moving beam reader or an imaging reader that employs a light source for emitting light to the symbol and a detector for detecting return light from the symbol. The light source can be a laser used in a moving beam reader, or an illuminator or an aiming source used in an imaging reader. A controller decodes the symbol by processing the return light, and controls the light emitted from the same light source to generate a visible indication signifying a successful decoding of the symbol on a surface bearing the symbol within a line of sight of an operator.

### DESCRIPTION OF THE RELATED ART

Moving laser beam readers or laser scanners, as well as solid-state imaging systems or imaging readers, have both been used to electro-optically read one-dimensional bar code symbols, particularly of the Universal Product Code (UPC) type, each having a row of bars and spaces spaced apart along one direction, and two-dimensional symbols, such as Code 49, which introduced the concept of vertically stacking a plurality of rows of bar and space patterns in a single symbol, as described in U.S. Pat. No. 4,794,239. Another two-dimensional code structure for increasing the amount of data that can be represented or stored on a given amount of surface area is known as PDF417 and is described in U.S. Pat. No. 5,304,786.

Moving laser beam readers generally include a housing, a laser for emitting a laser beam, a focusing lens assembly for focusing the laser beam to form a beam spot having a certain size at a focal plane in a range of working distances relative to the housing, a scan component for repetitively scanning the beam spot across a target symbol in a scan pattern, for example, a scan line or a series of scan lines, across the target symbol multiple times per second, e.g., one-hundred times per second, a photodetector for detecting light reflected and/or scattered from the target symbol and for converting the detected light into an analog electrical signal, and signal processing circuitry including a digitizer for digitizing the analog signal and a microprocessor for decoding the digitized signal based upon a specific symbology used for the target symbol. When the target symbol has been successfully decoded, the microprocessor sends an acknowledgment feedback signal to an audio circuit in the housing to produce an audible tone or beep, and/or to a visual indicator circuit to produce an indication light visible externally of the housing, to inform an operator holding the housing that a successful decode of the symbol being scanned and read has occurred, and that the operator can now proceed to the next symbol to be scanned and read.

The imaging reader includes a housing, a solid-state imager or sensor having an array of cells or photosensors, which correspond to image elements or pixels in a field of view of the imager, an illuminating light assembly for illuminating the field of view with illumination light from an illumination light source, e.g., a laser or one or more light emitting diodes (LEDs), and an imaging lens assembly for capturing return ambient and/or illumination light scattered and/or reflected from the symbol being imaged over a range of working distances. Such an imager may include a one- or two-dimensional charge coupled device (CCD) or a complementary metal oxide semiconductor (CMOS) device and associated circuits for producing electronic signals corresponding to a one- or two-dimensional array of pixel information over the field of view. Signal processing circuitry including a microprocessor processes the electronic signals to decode the target symbol. An aiming light generator may also be provided in the housing for projecting an aiming light pattern or mark on the target symbol prior to imaging. When the target symbol has been successfully decoded, the microprocessor sends an acknowledgment feedback signal to an audio circuit in the housing to produce an audible tone or beep, and/or to a visual indicator circuit to produce an indication light visible externally of the housing, to inform an operator holding the housing that a successful decode of the symbol being imaged and read has occurred, and that the operator can now proceed to the next symbol to be imaged and read.

As advantageous as both types of readers are in reading symbols, the operator may not hear the auditory beep signifying a successful decode if the background noise is too loud, or if the operator has a hearing impairment. Sometimes, the audio circuit is deliberately disabled in a library, hospital or like environment where constant beeping is deemed too disruptive or annoying, especially when many symbols are to be read over a brief time period. Also, the operator may not readily see the indication light signifying a successful decode if the background light is too bright, or if the operator has poor eyesight. Moreover, the operator's line of sight is typically centrally fixed on the target symbol during reading, whereas the indication light is visible on the housing in the operator's peripheral vision at best, usually at the edges of the operator's field of view. Thus, the operator often may not readily perceive the indication light, and this lack of effective reliable feedback can degrade reading performance.

For increased perception, the art has proposed in U.S. Pat. No. 5,684,287 mounting a vibration circuit in a moving laser beam reader to provide tactile feedback in which the housing vibrates in one's hand upon a successful decode. However, the use of a vibration circuit adds unacceptable bulk, weight, and cost to the reader, and also consumes excessive electrical power.

The art has also proposed in U.S. Pat. No. 7,387,246 mounting a totally separate light source, optics and a drive circuit in an imaging reader to project a luminous figure, e.g., a green light spot, upon a successful decode, in a direction towards a surface bearing the target symbol to which the operator's attention is directed, thereby minimizing the possibility that the operator has failed to see a visible indication that the symbol has been successfully decoded. However, the use of additional optical and electrical components to project the green light spot adds more bulk, weight, and cost to the reader, and also consumes more electrical power. Also, since the green light spot is typically projected into the center of the field of view of the imaging reader, the green light spot can miss a symbol, especially of small size, if the symbol is not located in the center of the field of view.

Accordingly, there is a need for a reader for, and a method of, reliably and effectively visibly indicating a successful decode within the operator's line of sight, without adding unacceptable bulk, weight, and cost to the reader, and also without consuming excessive electrical power.

### SUMMARY OF THE INVENTION

One feature of this invention resides, briefly stated, in reader for electro-optically reading a coded symbol, such as one- and/or two-dimensional bar code symbols. The reader includes a housing, preferably one having a handle held by an operator during the reading, and an actuatable trigger mounted on the handle for initiating the reading when actuated by the operator. A data capture assembly is supported by the housing for directing light emitted from a light source at the symbol, and for detecting return light from the symbol. A controller is operative for decoding the symbol by processing the return light, and for controlling the light emitted from the same light source to generate a visible indication signifying a successful decoding of the symbol on a surface bearing the symbol within a line of sight of the operator.

In one embodiment, the reader is a moving laser beam reader, which includes a laser for emitting the light as a laser beam, a scanner for sweeping the laser beam across the symbol as one scan line or a plurality of scan lines for reflection and scattering from the symbol as the return light, and a photodetector for detecting the return light. In this embodiment, the laser is employed as the light source from which the visible indication is generated. In one variant, the controller energizes and deenergizes the laser after the successful decoding of the symbol, and flashes or blinks the scan line as the visible indication, either once or a plurality of times. In another variant, the controller controls the scanner after the successful decoding of the symbol, and changes a width of the scan line as the visible indication, either once or a plurality of times.

In another embodiment, the reader is an imaging reader, which includes an illuminator for emitting the light as illumination light that illuminates the target, and a solid-state imager, such as a charge coupled device (CCD) or a complementary metal oxide semiconductor (CMOS) device, for detecting the return illumination light. In this embodiment, the illuminator is employed as the light source from which the visible indication is generated. In one variant, the controller energizes and deenergizes the illuminator after the successful decoding of the symbol, and flashes or blinks the illumination light as the visible indication, either once or a plurality of times.

An aiming light source may also be provided in the imaging reader for emitting an aiming beam and for projecting an aiming light pattern or mark on the symbol prior to imaging. In another variant, the aiming light source is employed as the light source from which the visible indication is generated. The controller energizes and deenergizes the aiming light source after the successful decoding of the symbol, and flashes or blinks the aiming beam as the visible indication, either once or a plurality of times.

For either reader, an energizable audio source is advantageously provided for generating an audible sound when energized. The controller is operative for controlling the audio source to generate an audible indication signifying a successful decoding of the symbol. More specifically, the controller, as previously noted, is operative for energizing and deenergizing the light source to turn the light emitted from the same light source on and off after the successful decoding of the symbol, and the controller is operative for energizing and deenergizing the audio source to turn the sound on and off after the successful decoding of the symbol. Advantageously, the controller is operative for simultaneously turning the light source on and the audio source off, and for simultaneously turning the light source off and the audio source on, to minimize power consumption.

Hence, in accordance with this invention, a successful decode is reliably and effectively visibly indicated within the operator's line of sight, without adding unacceptable bulk, weight, and cost to the reader, and also without consuming excessive electrical power. Reader performance is enhanced.

Another feature of this invention resides, briefly stated, in a method of electro-optically reading a coded symbol, which is performed by directing light emitted from a light source supported by a housing at the symbol, detecting return light from the symbol, decoding the symbol by processing the return light, and controlling the light emitted from the same light source to generate a visible indication signifying a successful decoding of the symbol on a surface bearing the symbol.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a handheld moving laser beam reader for electro-optically reading a coded symbol in accordance with one embodiment of the present invention;

FIG. 2 is a schematic diagram of a handheld imaging reader for electro-optically reading a coded symbol in accordance with another embodiment of the present invention; and

FIG. 3 is a flow chart depicting operation of the reader of FIG. 1 or FIG. 2 in accordance with the present invention.

### DETAILED DESCRIPTION OF THE PREFERRED EMBODIMENTS

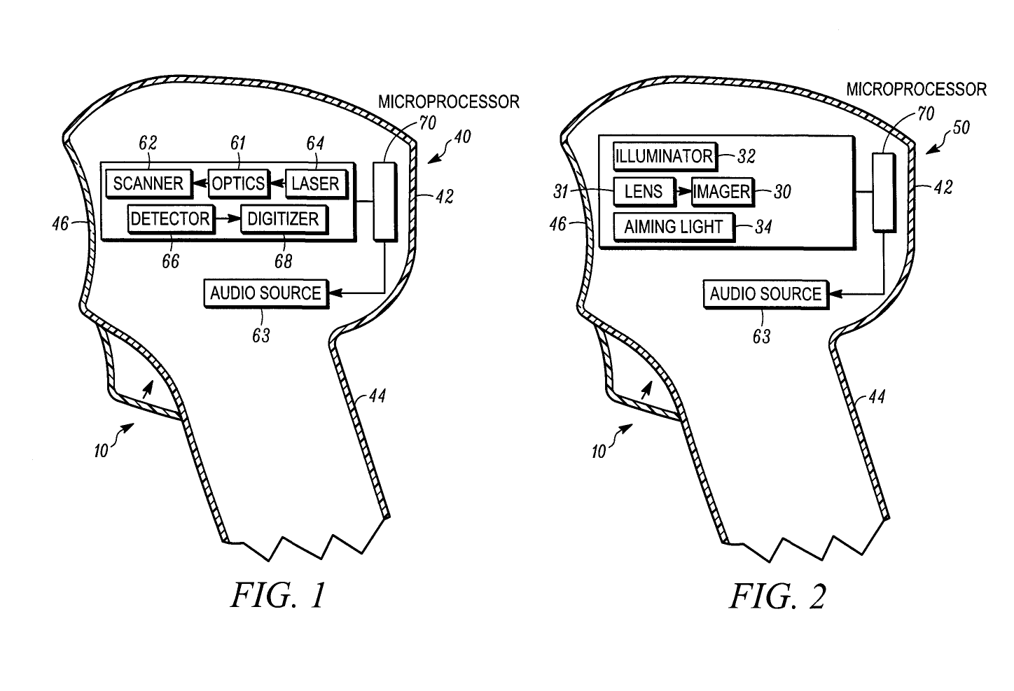

FIG. 1 depicts a moving laser beam reader 40 for electro-optically reading a target such as a coded symbol, that may use, and benefit from, the present invention. The beam reader 40 includes a scanner 62 in a handheld housing 42 having a handle 44 on which a trigger 10 for initiating reading is mounted. The scanner 62 is operative for scanning an outgoing laser beam from a laser 64 and/or a field of view of a light detector or photodiode 66 in a scan pattern, typically comprised of one or more scan lines, multiple times per second, for example, one-hundred times per second, through a window 46 across the symbol for reflection or scattering therefrom as return light detected by the photodiode 66 during reading. The beam reader 40 also includes a focusing lens assembly or optics 61 for optically modifying the outgoing laser beam to have a large depth of field, and a digitizer 68 for converting an electrical analog signal generated by the detector 66 from the return light into a digital signal for subsequent decoding by a microprocessor or controller 70 into data indicative of the symbol being read. When the symbol has been successfully decoded, the controller 70 sends an acknowledgment feedback signal to an audio source 63 in the housing 42 to produce an audible tone or beep, to inform an operator holding the housing 42 that a successful decode of the symbol being scanned and read has occurred, and that the operator can now proceed to the next symbol to be scanned and read.

FIG. 2 depicts an imaging reader 50 for imaging targets, such as indicia or coded symbols to be electro-optically read, which may use, and benefit from, the present invention. The imaging reader 50 includes a one- or two-dimensional, solid-state imager 30, preferably a CCD or a CMOS array, mounted in the handheld housing 42 having the handle 44 on which the trigger 10 for initiating reading is mounted. The imager 30 has an array of image sensors operative, together with an imaging lens assembly 31, for capturing return light reflected and/or scattered from the symbol through the window 46 during the imaging to produce an electrical signal indicative of a captured image for subsequent decoding by the controller 70 into data indicative of the symbol being read. When the symbol has been successfully decoded, the controller 70 sends an acknowledgment feedback signal to the audio source 63 in the housing 42 to produce an audible tone or beep, to inform an operator holding the housing 42 that a successful decode of the symbol being imaged and read has occurred, and that the operator can now proceed to the next symbol to be imaged and read.

The imaging reader 50 includes an illuminator 32 for illuminating the symbol during the imaging with illumination light directed from an illumination light source through the window 46. Thus, the return light may be derived from the illumination light and/or ambient light. The illumination light source comprises one or more light emitting diodes (LEDs) or a laser. An aiming light source 34 may also be provided for emitting an aiming beam and for projecting an aiming light pattern or mark on the symbol prior to imaging.

In operation of the imaging reader 50, the controller 70 sends a command signal to drive the illuminator LEDs/laser 32, typically continuously, or sometimes periodically, during scanning, and energizes the imager 30 during an exposure time period of a frame to collect light from the symbol during a short time period, say 500 microseconds or less. A typical array needs about 33 milliseconds to read the entire target image and operates at a frame rate of about 30 frames per second. The array may have on the order of one million addressable image sensors.

As noted above, the controller 70 of the prior art has another function, which is to send an acknowledgment feedback signal to a visual indicator circuit to produce an indication light visible externally of the housing 42, to visually inform the operator holding the housing 42 that a successful decode of the symbol being read has occurred, and that the operator can now proceed to the next symbol to be read. One aspect of this invention is to eliminate the extra bulk, weight, and cost of such a visual indicator circuit, and also to consume less electrical power without sacrificing the functionality of providing such a visible indication of a successful decode. Hence, in accordance with this invention, the same light source already present and used to perform data capture is also used to generate a visible indication signifying a successful decoding of the symbol on a surface bearing the symbol within a line of sight of the operator.

In the embodiment of FIG. 1, the laser 64 is employed as the light source from which the visible indication is generated. In one variant, the controller 70 energizes and deenergizes the laser 64 after the successful decoding of the symbol, and flashes or blinks the scan line as the visible indication, either once or a plurality of times. In another variant, the controller 70 controls the scanner 62 after the successful decoding of the symbol, and changes a width of the scan line as the visible indication, either once or a plurality of times.

In the embodiment of FIG. 2, the illuminator 32 is employed as the light source from which the visible indication is generated. In one variant, the controller 70 energizes and deenergizes the illuminator 32 after the successful decoding of the symbol, and flashes or blinks the illumination light as the visible indication, either once or a plurality of times. In another variant, the aiming light source 34 is employed as the light source from which the visible indication is generated. The controller 70 energizes and deenergizes the aiming light source 34 after the successful decoding of the symbol, and flashes or blinks the aiming beam as the visible indication, either once or a plurality of times.

For either reader, the controller 70, as previously noted, is operative for energizing and deenergizing the light source 64, 32, 34 to turn the light emitted from the same light source 64, 32, 34 on and off after the successful decoding of the symbol, and the controller 70 is also operative for energizing and deenergizing the audio source 63 to turn the sound on and off after the successful decoding of the symbol. Advantageously, the controller 70 is operative for simultaneously turning the light source 64, 32, 34 on and the audio source 63 off, and for simultaneously turning the light source 64, 32, 34 off and the audio source 63 on, to minimize power consumption.

Hence, in accordance with this invention, a successful decode is reliably and effectively visibly indicated within the operator's line of sight, without adding unacceptable bulk, weight, and cost to the reader, and also without consuming excessive electrical power. Reader performance is enhanced.

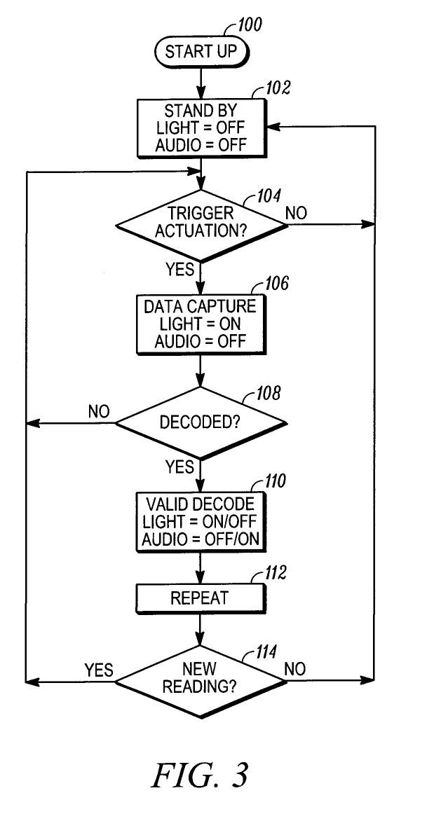

As shown in the flow chart of FIG. 3, each reader 10, 50, after a start-up 100 mode, enters a standby mode 102 in which the light source 64, 32, 34 and the audio source 63 are both deenergized or turned off, and the reader awaits the start of reading a target symbol. To initiate reading, the trigger 10 is actuated, typically by being manually depressed by the operator who is holding the reader in his or her hand. Data capture, as indicated by step 106, then begins.

In the case of the reader 10, the laser 64 is energized or turned on to emit a laser beam; the scanner 62 sweeps the laser beam; the detector 66 detects the return light and generates electrical analog signals; the digitizer 68 digitizes the analog signals; and the controller 70 decodes the digitized signals. The digitizer 68 could be combined in the controller 70. The audio source 63 is deenergized or turned off during data capture. The laser 64 is deenergized or turned off after data capture.

In the case of the reader 50, if the aiming light 34 is used, then it is energized or turned on to emit an aiming beam prior to scanning the symbol; the illuminator 32 is energized or turned on to emit illumination light during scanning of the symbol; the imager 30 detects reflected or scattered illumination light returning from the symbol and generates electrical signals; and the controller 70 decodes the electrical signals. The audio source 63 is deenergized or turned off during data capture. The aiming light 34 is deenergized or turned off during data capture. The illuminator 32 is deenergized or turned off after data capture.

At step 108, the controller 70 determines whether the symbol has been successfully decoded. If not, then the reader returns to awaiting the next trigger actuation. If so, then the controller 70 generates an acknowledgment feedback signal at step 110 and energizes or turns on one of the aforementioned light sources, e.g., the laser 64, the aiming source 34, or the illuminator 32, and then periodically deenergizes or turns off the aforementioned light source 64, 32, 34, thereby flashing or blinking the emitted light on the symbol a plurality of times (at repeat step 112) after the successful decode has occurred. Preferably, the controller 70 also energizes or turns on the audio source 63, and then periodically deenergizes or turns off the audio source 63, thereby signifying that a successful decode has occurred by the intermittent broadcasting of the emitted sound a plurality of times (at repeat step 112). As discussed above, it is preferable to minimize power consumption if the light source and the audio source are not simultaneously energized, but alternately energized. After a predetermined number of light flashes and intermittent beeps, the reader awaits a new reading at step 114.

It will be understood that each of the elements described above, or two or more together, also may find a useful application in other types of constructions differing from the types described above. For example, in a variant construction, as described above, rather than flashing the light emitted by the light source, another characteristic of the light can be changed. For example, the intensity of the emitted light can be varied, or the controller 70 can control the scanner 62 after the successful decoding of the symbol, and change a width of the scan line as the visible indication, either once or a plurality of times.

While the invention has been illustrated and described as embodied in electro-optical readers having visible indications of successful decodes in the lines of sight of the operators, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A reader for electro-optically reading a coded symbol, comprising:
a housing;
a data capture assembly supported by the housing for directing light emitted from a light source at the symbol, and for detecting return light from the symbol; and
a controller for decoding the symbol by processing the return light, and for controlling the light emitted from the same light source to generate a visible indication signifying a successful decoding of the symbol on a surface bearing the symbol.

2. The reader of claim 1, wherein the housing has a handle held by an operator during the reading, and an actuatable trigger mounted on the handle for initiating the reading when actuated by the operator; and wherein the controller generates the visible indication within a line of sight of the operator.

3. The reader of claim 1, wherein the light source is a laser for emitting the light as a laser beam; and wherein the data capture assembly includes a scanner for sweeping the laser beam as a scan line across the symbol; and wherein the controller energizes and deenergizes the laser after the successful decoding of the symbol, and flashes the scan line as the visible indication.

4. The reader of claim 1, wherein the light source is a laser for emitting the light as a laser beam; and wherein the data capture assembly includes a scanner for sweeping the laser beam as a scan line across the symbol; and wherein the controller controls the scanner after the successful decoding of the symbol, and changes a width of the scan line as the visible indication.

5. The reader of claim 1, wherein the light source is an illuminator for emitting the light as illumination light that illuminates the symbol; and wherein the data capture assembly includes an imager for detecting return illumination light; and wherein the controller energizes and deenergizes the illuminator after the successful decoding of the symbol, and flashes the illumination light as the visible indication.

6. The reader of claim 1, wherein the light source is an aiming light for emitting the light as an aiming beam prior to reading; and wherein the data capture assembly includes an imager for detecting the return light during reading; and wherein the controller energizes and deenergizes the aiming light after the successful decoding of the symbol, and flashes the aiming beam as the visible indication.

7. The reader of claim 1, and an energizable audio source for generating an audible sound when energized; and wherein the controller is operative for controlling the audio source to generate an audible indication signifying a successful decoding of the symbol.

8. The reader of claim 7, wherein the controller is operative for energizing and deenergizing the light source to turn the light emitted from the same light source on and off after the successful decoding of the symbol, and wherein the controller is operative for energizing and deenergizing the audio source to turn the sound on and off after the successful decoding of the symbol; and wherein the controller is operative for simultaneously turning the light source on and the audio source off, and for simultaneously turning the light source off and the audio source on, to minimize power consumption.

9. The reader of claim 1, wherein the controller is operative for energizing and deenergizing the light source to turn the light emitted from the same light source on and off a plurality of times after the successful decoding of the symbol.

10. A method of electro-optically reading a coded symbol, comprising the steps of:
directing light emitted from a light source supported by a housing at the symbol;
detecting return light from the symbol;
decoding the symbol by processing the return light; and
controlling the light emitted from the same light source to generate a visible indication signifying a successful decoding of the symbol on a surface bearing the symbol.

11. The method of claim 10, and holding the housing by an operator during the reading, and initiating the reading by manual actuation of a trigger by the operator; and wherein the controlling step is performed by generating the visible indication within a line of sight of the operator.

12. The method of claim 10, wherein the directing step is performed by using a laser as the light source for emitting the light as a laser beam; and sweeping the laser beam as a scan line across the symbol; and energizing and deenergizing the laser after the successful decoding of the symbol, and flashing the scan line as the visible indication.

13. The method of claim 10, wherein the directing step is performed by using a laser as the light source for emitting the light as a laser beam; and sweeping the laser beam as a scan line across the symbol; and changing a width of the scan line as the visible indication after the successful decoding of the symbol.

14. The method of claim 10, wherein the directing step is performed by using an illuminator as the light source for emitting the light as illumination light that illuminates the symbol; and detecting return illumination light; and energizing and deenergizing the illuminator after the successful decoding of the symbol, and flashing the illumination light as the visible indication.

15. The method of claim 10, wherein the directing step is performed by using an aiming light as the light source for emitting the light as an aiming beam prior to reading; and energizing and deenergizing the aiming light after the successful decoding of the symbol, and flashing the aiming beam as the visible indication.

16. The method of claim 10, and generating an audible sound as an audible indication signifying a successful decoding of the symbol from an audio source.

17. The method of claim 16, and energizing and deenergizing the light source to turn the light emitted from the same light source on and off after the successful decoding of the symbol, and energizing and deenergizing the audio source to turn the sound on and off after the successful decoding of the symbol; and simultaneously turning the light source on and the audio source off, and simultaneously turning the light source off and the audio source on, to minimize power consumption.

18. The method of claim 10, and energizing and deenergizing the light source to turn the light emitted from the same light source on and off a plurality of times after the successful decoding of the symbol.

19. A reader for electro-optically reading a coded symbol, comprising:
data capture means supported by the reader for directing light emitted from light means at the symbol, and for detecting return light from the symbol; and
control means for decoding the symbol by processing the return light, and for controlling the light emitted from the same light means to generate a visible indication signifying a successful decoding of the symbol on a surface bearing the symbol.

20. The reader of claim 19, wherein the control means generates the visible indication within a line of sight of an operator holding the reader during reading.
